(19) United States
(12) Patent Application Publication
(10) Pub. No.: US 2011/0114067 A1
(43) Pub. Date: May 19, 2011

(54) ENGINE INCLUDING VALVE LIFT ASSEMBLY FOR INTERNAL EGR CONTROL

(75) Inventors: MANUEL ANGEL GONZALEZ DELGADO, ROCHESTER HILLS, MI (US); ROBERT J. MORAN, ANN ARBOR, MI (US); SAMEER BHARGAVA, CANTON, MI (US); RONALD JAY PIERIK, HOLLY, MI (US); JONATHAN L. BURTON, WESTMINSTER, CO (US)

(73) Assignee: GM GLOBAL TECHNOLOGY OPERATIONS, INC., DETROIT, MI (US)

(21) Appl. No.: 12/621,070

(22) Filed: Nov. 18, 2009

(51) Int. Cl. F02M 25/07; F01L 1/34

(52) U.S. Cl. 123/568.11; 123/90.15

(57) ABSTRACT

An engine assembly may include a first exhaust valve lift assembly, a first exhaust valve, and a first camshaft. The first exhaust valve lift assembly may be operable in first and second operating modes. The first exhaust valve may be engaged with the first exhaust valve lift assembly and may be in communication with an engine combustion chamber. The first camshaft may include a first exhaust lobe engaged with the first exhaust valve lift assembly and defining a profile including a first exhaust region and a first exhaust gas recirculation (EGR) region. The first exhaust valve may remain closed when the first EGR region engages the first exhaust valve lift assembly during the first operating mode and may be opened when the first EGR region engages the first exhaust valve lift assembly during the second operating mode to provide exhaust gas flow into the combustion chamber during an intake stroke.

### GOVERNMENT LICENSE RIGHTS

The Government of the United States of America has rights in this invention pursuant to Contract No. DE-FC26-05NT42415 awarded by the United States Department of Energy.

### FIELD

The present disclosure relates to engine assemblies, and more specifically to engine exhaust gas recirculation systems.

### BACKGROUND

This section provides background information related to the present disclosure which is not necessarily prior art.

Internal combustion engines may include exhaust gas recirculation (EGR) systems to improve emissions. These systems typically include additional conduits providing communication between the exhaust system of the engine and the combustion chamber during an intake stroke. Alternate systems exist where the exhaust valve is opened during the intake stroke to provide exhaust gas flow to the combustion chamber. However, these systems continuously provide EGR (i.e., on each intake stroke) even when it may not be needed.

### SUMMARY

An engine assembly may include an engine structure, a first exhaust valve lift assembly, a first exhaust valve, and a first camshaft. The engine structure may define a combustion chamber. The first exhaust valve lift assembly may be supported by the engine structure and may be operable in first and second operating modes. The first exhaust valve may be engaged with the first exhaust valve lift assembly and may be in communication with the combustion chamber. The first camshaft may include a first exhaust lobe engaged with the first exhaust valve lift assembly and defining a profile including a first exhaust region and a first exhaust gas recirculation (EGR) region. The first exhaust valve may remain closed when the first EGR region engages the first exhaust valve lift assembly during the first operating mode and the first exhaust valve may be opened when the first EGR region engages the first exhaust valve lift assembly during the second operating mode to provide exhaust gas flow into the combustion chamber during an intake stroke of the engine assembly.

A method of controlling exhaust gas recirculation in an engine assembly may include opening a first exhaust valve of an engine combustion chamber during exhaust strokes via an engagement between a first exhaust valve lift mechanism, a first exhaust cam lobe and the first exhaust valve. The method may further include opening an intake valve of the engine combustion chamber during intake strokes immediately subsequent to the exhaust strokes. The first exhaust valve lift mechanism is operated in a first operating mode during a first of the intake strokes and a second operating mode during a second of the intake strokes. A first operating mode may include the first exhaust valve remaining closed between exhaust strokes. A second operating mode may include the first exhaust valve being opened between exhaust strokes during the second intake stroke via the first exhaust cam lobe and providing exhaust gas recirculation to the cylinder during the second intake stroke.

An alternate method of controlling exhaust gas recirculation in an engine assembly may include opening a first exhaust valve of an engine combustion chamber during exhaust strokes via an engagement between a first exhaust valve lift mechanism, a first exhaust cam lobe and the first exhaust valve. The method may further include opening a second exhaust valve of the engine combustion chamber during exhaust strokes via an engagement between a second exhaust valve lift mechanism, a second exhaust cam lobe and the second exhaust valve. An intake valve of the engine combustion chamber may be opened during intake strokes immediately subsequent to the exhaust strokes. The first and second exhaust valve lift mechanisms may be operated in a first operating mode during a first of the intake strokes. The first operating mode may include the first and second exhaust valves remaining closed between exhaust strokes. In another operating condition the first exhaust valve lift mechanism may be operated in the first operating mode and the second exhaust valve lift mechanism may be operated in the second operating mode during a second of the intake strokes. The second operating mode may include the second exhaust valve being opened between exhaust strokes during the second intake stroke via the exhaust cam lobe and providing exhaust gas recirculation to the cylinder during the second intake stroke. The first and second valve lift mechanisms may both be operated in the second operating mode during a third of the intake strokes.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is an illustration of the engine assembly according to the present disclosure;

FIG. 2 is an exploded view of the exhaust camshaft and valve lift assemblies of the engine assembly shown in FIG. 1;

FIG. 3 is a schematic illustration of a first exhaust cam lobe profile according to the present disclosure;

FIG. 4 is a schematic illustration of a second exhaust cam lobe profile according to the present disclosure;

FIG. 5 is a schematic illustration of a first oil routing to the exhaust valve lift assemblies of the engine assembly shown in FIG. 1;

FIG. 6 is a schematic illustration of a second oil routing to the exhaust valve lift assemblies of the engine assembly shown in FIG. 1; and

FIG. 7 is a graphical illustration of intake and exhaust valve lift according to the present disclosure.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

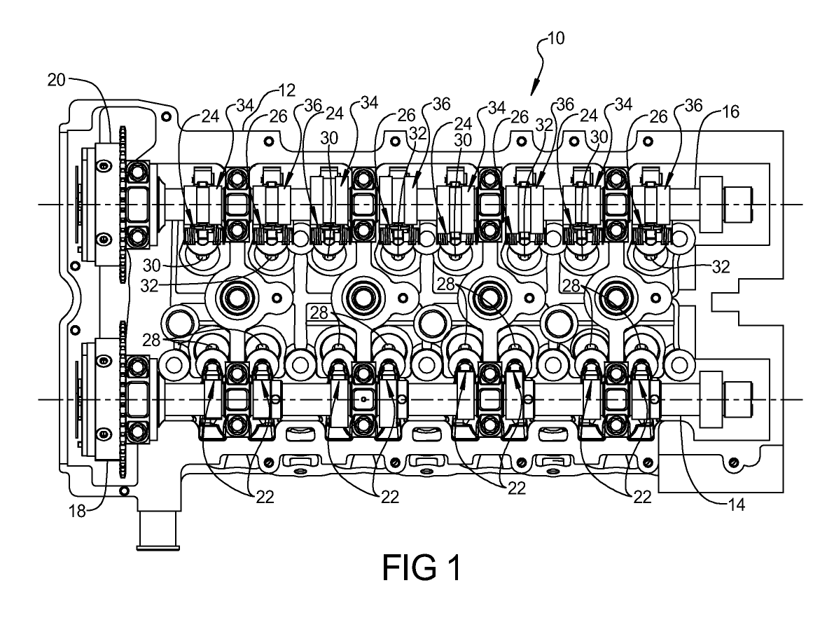

With reference to FIG. 1, an engine assembly 10 may include an engine structure 12, intake and exhaust camshafts 14, 16 rotationally supported on the engine structure 12, intake and exhaust cam phasers 18, 20, intake valve lift assemblies 22, first and second exhaust valve lift assemblies 24, 26, intake valves 28, and first and second exhaust valves 30, 32. The intake cam phaser 18 may be coupled to the intake camshaft 14 and the exhaust cam phaser 20 may be coupled to the exhaust camshaft 16. In the present non-limiting example, the engine assembly 10 is shown as a dual overhead camshaft engine (with a single cylinder head illustrated) where the engine structure 12 supporting the camshafts 14, 16 is the cylinder head. However, the present disclosure is not limited to dual overhead camshaft arrangements and applies equally to single overhead camshaft engines as well as cam-in-block engines.

By way of non-limiting example, in the dual overhead camshaft arrangement illustrated, each combustion chamber (cylinder) may have two intake valve lift assemblies 22, two intake valves 28, a first and a second exhaust valve lift assembly 24, 26, and first and second exhaust valves 30, 32 associated therewith. For simplicity, the following discussion will describe the first and second exhaust valve lift assemblies 24, 26 and first and second exhaust valves 30, 32 for one combustion chamber, with the understanding that the description applies equally to the remaining combustion chambers.

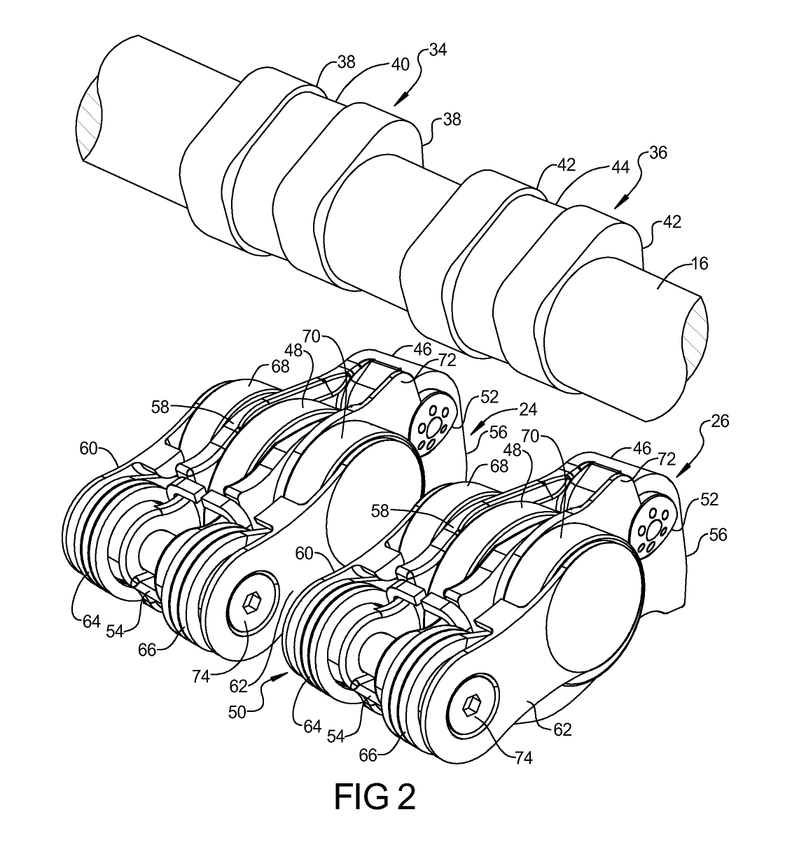

With additional reference to FIG. 2, the exhaust camshaft 16 may include first and second lobes 34, 36. The first lobes 34 may include first auxiliary lobe members 38 and a first primary lobe member 40. Similarly, the second lobes 36 may include second auxiliary lobe members 42 and a second primary lobe member 44. The first lobes 34 may be engaged with the first exhaust valve lift assemblies 24 and the second lobes 36 may be engaged with the second exhaust valve lift assemblies 26. The first and second exhaust valve lift assemblies 24, 26 may be similar to one another. Therefore, for simplicity, the first exhaust valve lift assembly 24 will be described in detail with the understanding that the description applies equally to the second exhaust valve lift assembly 26.

By way of non-limiting example, the first exhaust valve lift assembly 24 may form a multi-step rocker arm assembly including a lever body 46, a first roller assembly 48, an arm assembly 50, and a locking mechanism 52. The lever body 46 may include a first end 54, a second end 56, and a medial portion 58 located between the first and second ends 54, 56. The first roller assembly 48 may be fixed for pivotal displacement with the lever body 46 at the medial portion 58. The first end 54 may be engaged with the first exhaust valve 30 for actuation of the first exhaust valve 30. The second end 56 may be engaged with and pivotally supported by the engine structure 12. By way of non-limiting example, the second end 56 may be supported by a hydraulic lash adjuster (not shown) and the lash adjuster may provide pressurized oil to the first exhaust valve lift assembly 24.

The arm assembly 50 may include first and second arms 60, 62, first and second biasing members 64, 66, second and third roller assemblies 68, 70, a latch 72, and a fastener 74. The fastener 74 may pivotally couple first ends of the first and second arms 60, 62 to the lever body 46. The second roller assembly 68 may be coupled to a second end of the first arm 60 and the third roller assembly 70 may be coupled to a second end of the second arm 62. The first and second arms 60, 62, the second and third roller assemblies 68, 70, and the latch 72 may each be fixed for pivotal displacement with one another. The first and second biasing members 64, 66 may bias the arm assembly 50 against the first lobe 34. The first auxiliary lobe members 38 may be engaged with the second and third roller assemblies 68, 70 and the first primary lobe member 40 may be engaged with the first roller assembly 48.

During operation, the first exhaust valve lift assembly 24 may be switched between first and second lift modes by actuating the locking mechanism 52. The locking mechanism 52 may be actuated by pressurized fluid. In the first lift mode, the locking mechanism 52 disengages the latch 72. Therefore, when the first auxiliary lobe members 38 engage the second and third roller assemblies 68, 70, the arm assembly 50 is pivotally displaced relative to the lever body 46. The first primary lobe member 44 engages the first roller assembly 48 and pivotally displaces the lever body 46 to open the first exhaust valve 30.

In the second lift mode, the latch 72 is engaged with the locking mechanism 52, coupling the arm assembly 50 for pivotal displacement with the lever body 46. Therefore, when the first auxiliary lobe members 38 engage the second and third roller assemblies 68, 70, the lever body 46 is pivotally displaced and the exhaust valve 30 is opened by the first auxiliary lobe members 38.

While described as a multi-step rocker arm assembly, it is understood that the present disclosure is not limited to rocker arm assemblies and is equally applicable to any valve lift assembly capable of varying valve lift based on engagement with a cam lobe. By way of non-limiting example, the present disclosure applies equally to shaft mounted switching valve train mechanisms or continuously variable valve lift (CVVL) mechanisms (not shown).

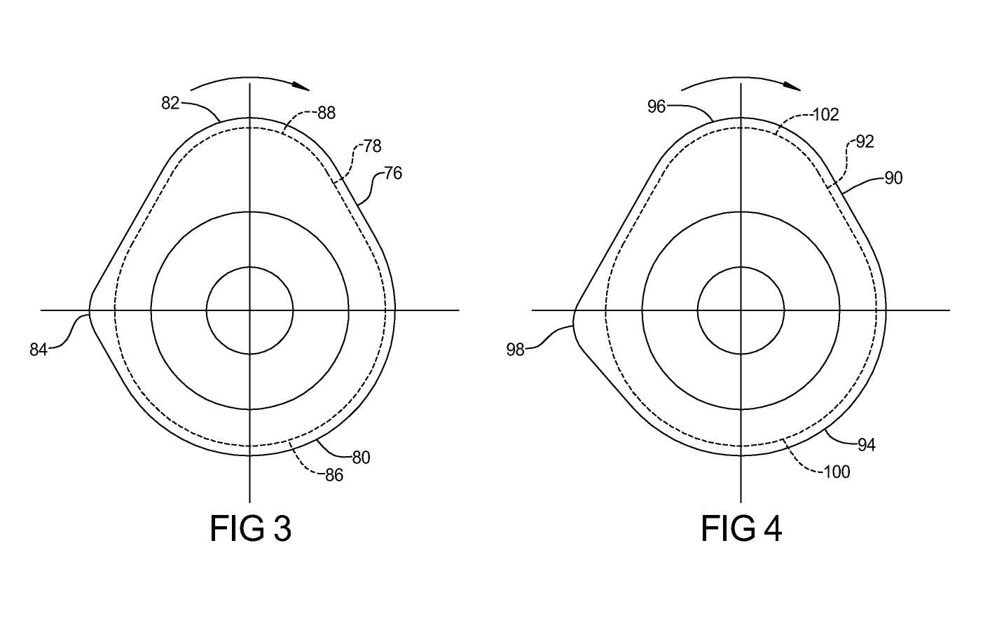

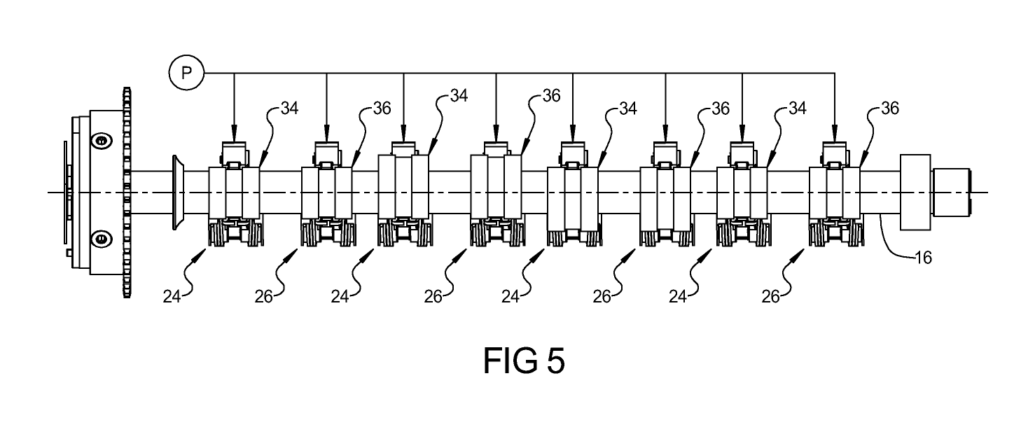

With reference to FIG. 3, first and second exemplary lobe profiles 76, 78 are illustrated. The first lobe profile 76 may include a base region 80, an exhaust lift region 82 and an exhaust gas recirculation (EGR) lift region 84. The second lobe profile 78 may include a base region 86 and an exhaust lift region 88. With reference to FIG. 4, third and fourth exemplary lobe profiles 90, 92 are illustrated. The third lobe profile 90 may include a base region 94, an exhaust lift region 96 and an EGR lift region 98. The exhaust lift region 96 and the exhaust lift region 88 may be similar to one another. The EGR lift region 98 may provide a greater valve open duration than the EGR lift region 84. The fourth lobe profile 92 may include a base region 100 and an exhaust lift region 102 similar to the second lobe profile 78.

In a first non-limiting example, the first and second lobes 34, 36 of the exhaust camshaft 16 may each have the profiles illustrated in FIG. 3. More specifically, first and second auxiliary lobe members 38, 42 may each have the first lobe profile 76 and the first and second primary lobe members 40, 44 may each have the second lobe profile 78. As shown in FIG. 5, each of the first and second exhaust valve lift assemblies 24, 26 may share a common pressurized fluid source (P). Therefore, the first and second exhaust valve lift assemblies 24, 26 are either both in the first operating mode or both in the second operating mode.

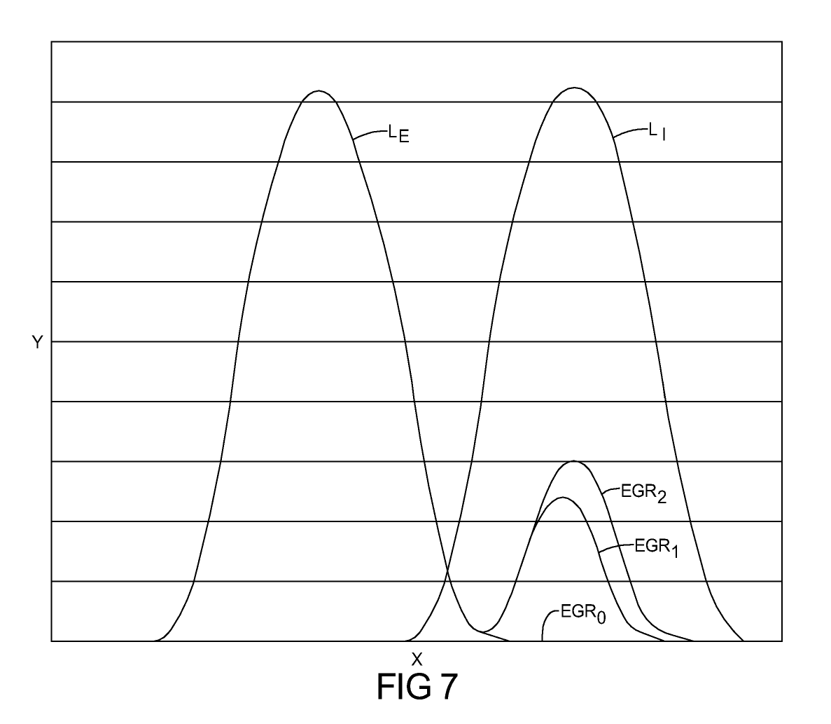

FIG. 7 illustrates an exhaust valve lift (L_{E}) and a subsequent intake valve lift (L_{I}) for a given cylinder. The x-axis represents camshaft angle and the y-axis represents lift. During operation of the first non-limiting example, a single EGR capacity is provided. Specifically, when the first and second exhaust valve lift assemblies 24, 26 are operated in the first operating mode there is no EGR provided by the EGR lift region 84 (EGR₀). When the first and second exhaust valve lift assemblies 24, 26 are operated in the second operating mode, EGR is provided by the first and second exhaust valves 30, 32 being reopened (EGR₁) during the intake stroke (L_{I}).

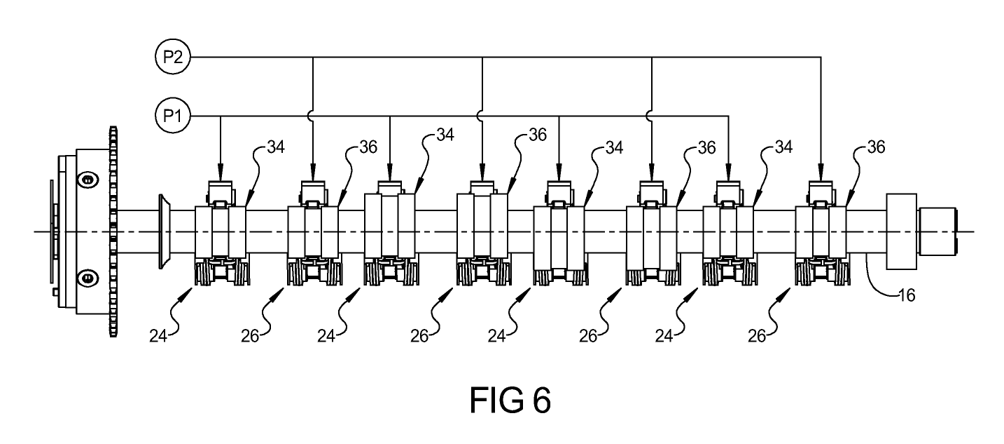

In a second non-limiting example, the first and second lobes 34, 36 of the exhaust camshaft 16 may each have the profiles illustrated in FIG. 3 similar to the first non-limiting example. However, as shown in FIG. 6, the first exhaust valve lift assemblies 24 may be in communication with a first pressurized fluid source (P1) and the second exhaust valve lift assemblies 26 may be in communication with a second pressurized fluid source (P2) isolated from the first pressurized fluid source (P1). Therefore, the first and second exhaust valve lift assemblies 24, 26 may be operated in the first and second operating modes independently from one another. Therefore, first and second EGR capacities are provided.

Specifically, when the first and second exhaust valve lift assemblies 24, 26 are operated in the first operating mode there is no EGR provided by the EGR lift region 84 (EGR₀). When the first exhaust valve lift assemblies 24 are operated in the second operating mode and the second exhaust valve lift assemblies 26 are operated in the first operating mode, a first EGR capacity is provided by the first exhaust valves 30 being reopened (EGR₁) during the intake stroke (L_{I}) and the second exhaust valves 30 remaining closed (EGR₀). When the first and second exhaust valve lift assemblies 24, 26 are operated in the second operating mode, a second EGR capacity is provided by the first and second exhaust valves 30, 32 being reopened (EGR₁) during the intake stroke (L_{I}). The second EGR capacity is greater than the first EGR capacity.

In a third non-limiting example, the first lobes 34 of the exhaust camshaft 16 may each have the profiles illustrated in FIG. 3 and the second lobes 36 may have the profiles illustrated in FIG. 4. More specifically, first auxiliary lobe members 38 may each have the first lobe profile 76 and the first primary lobe members 40 may each have the second lobe profile 78. The second auxiliary lobe members 42 may each have the third lobe profile 90 and the second primary lobe members may each have the fourth lobe profile 92.

As shown in FIG. 6, the first exhaust valve lift assemblies 24 may a first pressurized fluid source (P1) and the second exhaust valve lift assemblies 26 may a second pressurized fluid source (P2) isolated from the first pressurized fluid source (P1). Therefore, the first and second exhaust valve lift assemblies 24, 26 may be operated in the first and second operating modes independently from one another. Therefore, first, second and third EGR capacities are provided.

As illustrated in FIG. 7, when the first and second exhaust valve lift assemblies 24, 26 are operated in the first operating mode there is no EGR provided by the EGR lift region 84 (EGR₀). When the first exhaust valve lift assemblies 24 are operated in the second operating mode and the second valve assemblies 26 are operated in the first operating mode, a first EGR capacity is provided by the first exhaust valves 30 being reopened (EGR₁) during the intake stroke (L_{I}) and the second exhaust valves 30 remaining closed (EGR₀). When the first exhaust valve lift assemblies 24 are operated in the first operating mode and the second valve assemblies 26 are operated in the second operating mode, a second EGR capacity is provided by the first exhaust valves 30 remaining closed (EGR₀) during the intake stroke (L_{I}) and the second exhaust valves 30 being reopened (EGR₂). The second EGR capacity is greater than the first EGR capacity due to the greater lift provided by the EGR lift region 98. When the first and second exhaust valve lift assemblies 24, 26 are both operated in the second operating mode, a third EGR capacity is provided by the first and second exhaust valves 30, 32 being reopened (EGR₁, EGR₂) during the intake stroke (L_{I}). The third EGR capacity is greater than the second EGR capacity.

What is claimed is:

1. An engine assembly comprising:
an engine structure defining a combustion chamber;
a first exhaust valve lift assembly supported by the engine structure and operable in first and second operating modes;
a first exhaust valve engaged with the first exhaust valve lift assembly and in communication with the combustion chamber; and
a first camshaft including a first exhaust lobe engaged with the first exhaust valve lift assembly and defining a profile including a first exhaust region and a first exhaust gas recirculation (EGR) region, the first exhaust valve remaining closed when the first EGR region engages the first exhaust valve lift assembly during the first operating mode and the first exhaust valve being opened when the first EGR region engages the first exhaust valve lift assembly during the second operating mode to provide exhaust gas flow into the combustion chamber during an intake stroke of the engine assembly.

2. The engine assembly of claim 1, further comprising a second exhaust valve lift assembly operable in the first and second modes and supported by the engine structure, a second exhaust valve engaged with the second exhaust valve lift assembly and in communication with the combustion chamber, the first camshaft including a second exhaust lobe engaged with the second exhaust valve lift assembly and defining a profile including a second exhaust region and a second EGR region, the second exhaust valve remaining closed when the second EGR region engages the second exhaust valve lift assembly during the first operating mode and the second exhaust valve being opened when the second EGR region engages the second valve lift assembly during the second operating mode to provide exhaust gas flow into the combustion chamber during the intake stroke of the engine assembly.

3. The engine assembly of claim 2, wherein the first EGR region defines a first lift profile providing a first opening duration for the first exhaust valve and the second EGR region defines a second lift profile providing a second opening duration for the second exhaust valve equal to the first opening duration.

4. The engine assembly of claim 2, wherein the first EGR region defines a first lift profile providing a first opening duration for the first exhaust valve and the second EGR region defines a second lift profile providing a second opening duration for the second exhaust valve greater than the first opening duration.

5. The engine assembly of claim 2, wherein the first and second exhaust valve lift assemblies are hydraulically actuated between the first and second operating modes, the first exhaust valve lift assembly being in communication with a first pressurized fluid source during the first operating mode of the first exhaust valve lift assembly and the second exhaust valve lift assembly being in communication with a second pressurized fluid source during the first operating mode of the second exhaust valve lift assembly.

6. The engine assembly of claim 5, wherein the first and second pressurized fluid sources are isolated from one another.

7. The engine assembly of claim 6, wherein the first and second exhaust valve lift assemblies provide an EGR off condition where the first and second exhaust valve lift assemblies are both in the first operating mode, a first EGR capacity where the first exhaust valve lift assembly is in the first operating mode and the second exhaust valve lift assembly is in the second operating mode, a second EGR capacity where the first exhaust valve lift assembly is in the second operating mode and the second exhaust valve lift assembly is in the first operating mode, and a third EGR capacity where the first and second exhaust valve lift assemblies are both in the second operating mode.

8. The engine assembly of claim 7, wherein the first EGR region defines a first lift profile providing a first opening duration for the first exhaust valve and the second EGR region defines a second lift profile providing a second opening duration for the second exhaust valve greater than the first opening duration.

9. The engine assembly of claim 1, wherein the first exhaust lobe includes first and second lobe members axially spaced from one another, the first lobe member defining the first exhaust region and the second lobe member including the first EGR region and a second exhaust region.

10. The engine assembly of claim 9, wherein the first exhaust valve lift assembly includes a multi-step rocker arm having a main body and a first arm, the first lobe member engaged with the main body and the second lobe member engaged with the first arm, the first arm displaceable relative to the main body during the first operating mode and fixed for displacement with the main body during the second operating mode.

11. A method comprising:
opening a first exhaust valve of an engine combustion chamber during exhaust strokes via an engagement between a first exhaust valve lift mechanism, a first exhaust cam lobe and the first exhaust valve;
opening an intake valve of the engine combustion chamber during intake strokes immediately subsequent to the exhaust strokes;
operating the first exhaust valve lift mechanism in a first operating mode during a first of the intake strokes, the first operating mode including the first exhaust valve remaining closed between exhaust strokes; and
operating the first exhaust valve lift mechanism in a second operating mode during a second of the intake strokes, the second operating mode including the first exhaust valve being opened between exhaust strokes during the second intake stroke via the first exhaust cam lobe and providing exhaust gas recirculation to the cylinder during the second intake stroke.

12. The method of claim 11, further comprising opening a second exhaust valve of the engine combustion chamber during exhaust strokes via an engagement between a second exhaust valve lift mechanism, a second exhaust cam lobe and the second exhaust valve, the second exhaust valve lift mechanism being operable in the first and second operating modes, the first operating mode including the second exhaust valve remaining closed between exhaust strokes and the second operating mode including the second exhaust valve being opened between exhaust strokes to provide exhaust gas recirculation between exhaust strokes.

13. The method of claim 12, further comprising operating the second exhaust valve lift mechanism in the first operating mode during the first intake stroke and operating the second exhaust valve lift mechanism in the second operating mode during the second intake stroke.

14. The method of claim 12, further comprising operating the second exhaust valve lift mechanism in the second operating mode during the first intake stroke and operating the second exhaust valve lift mechanism in the first operating mode during the second intake stroke.

15. The method of claim 12, wherein the opening duration of the second exhaust valve providing exhaust gas recirculation during the second operating mode is greater than the opening duration of the first exhaust valve providing exhaust gas recirculation during the second operating mode.

16. The method of claim 12, wherein a common pressurized fluid source controls operation of the first and second exhaust valve lift mechanisms in the first and second operating modes.

17. The method of claim 12, wherein a first pressurized fluid source controls operation of the first and second exhaust valve lift mechanisms in the first operating mode and a second pressurized fluid source controls operation of the second exhaust valve lift mechanism in the first and second operating modes, the first and second pressurized fluid sources being isolated from one another and operating the first and second exhaust valve lift mechanisms in the first and second operating modes independently from one another.

18. A method comprising:
opening a first exhaust valve of an engine combustion chamber during exhaust strokes via an engagement between a first exhaust valve lift mechanism, a first exhaust cam lobe and the first exhaust valve;
opening a second exhaust valve of the engine combustion chamber during exhaust strokes via an engagement between a second exhaust valve lift mechanism, a second exhaust cam lobe and the second exhaust valve;
opening an intake valve of the engine combustion chamber during intake strokes immediately subsequent to the exhaust strokes;
operating the first and second exhaust valve lift mechanisms in a first operating mode during a first of the intake strokes, the first operating mode including the first and second exhaust valves remaining closed between exhaust strokes;
operating the first exhaust valve lift mechanism in the first operating mode and operating the second exhaust valve lift mechanism in a second operating mode during a second of the intake strokes, the second operating mode including the second exhaust valve being opened between exhaust strokes during the second intake stroke via the second exhaust cam lobe and providing exhaust gas recirculation to the cylinder during the second intake stroke; and
operating the first and second exhaust valve lift mechanisms in the second operating mode during a third of the intake strokes.

19. The method of claim 18, wherein the opening duration of the second exhaust valve providing exhaust gas recirculation during the second operating mode is greater than the opening duration of the first exhaust valve providing exhaust gas recirculation during the second operating mode.

20. The method of claim 19, further comprising operating the first exhaust valve lift mechanism in the second operating mode and operating the second exhaust valve lift mechanism in the first operating mode during a fourth of the intake strokes.
